(19) United States
(12) Patent Application Publication
(10) Pub. No.: US 2026/0057658 A1
(43) Pub. Date: Feb. 26, 2026

(54) NEURAL RADIANCE FIELD TRAINING USING SPATIALLY DYNAMIC LOSS FUNCTIONS

(71) Applicant: Mitsubishi Electric Research Laboratories, Inc., Cambridge, MA (US)

(72) Inventors: Pedro Miraldo, Cambridge, MA (US); Goncalo Pais, Lisbon (PT); Moitreya Chatterjee, Cambridge, MA (US)

(73) Assignee: Mitsubishi Electric Research Laboratories, Inc., Cambridge, MA (US)

(21) Appl. No.: 18/812,255

(22) Filed: Aug. 22, 2024

(51) Int. Cl. G06V 10/82; G06V 10/56; G06V 10/60

(52) U.S. Cl. CPC G06V 10/82; G06V 10/56; G06V 10/60

(57) ABSTRACT

Systems, methods, software, and devices are disclosed herein for training a neural network using multiple images of a scene captured from different viewing directions. A method of training the network includes identifying pixels in multiple images of a scene captured from different viewing directions. and determining, for each of the pixels, at least a known color value, a known radiance value, and a spatial value. The training minimizes a loss function having multiple loss terms: a first loss term that is dependent upon at least the known color value and the known radiance value for each of the pixels; and one or more additional loss terms dependent upon the spatial value determined for each pixel, such that the loss function varies for at least some of the pixels.

### TECHNICAL FIELD

Aspects of the disclosure are related to the field of computer vision technology, and in particular, to the training of neural networks for multiple-view reconstruction and novel view rendering.

### BACKGROUND

A neural radiance field—or NeRF—is a type of neural network trained on a sparse set of two-dimensional (2D) images of a three-dimensional (3D) scene to provide novel views of the 3D scene. NeRFs represent a 3D scene as a continuous function that maps 3D coordinates to color and radiance values. Unlike traditional methods that use discrete meshes or point clouds to represent scenes, NeRFs work with a continuous representation, allowing for more detailed and accurate reconstructions.

Despite their advantages, NeRFs take a long time to train. Training a NeRF involves projecting a ray from an image pixel into a scene, and inputting 3D coordinates of voxels along the ray into a neural network. The network outputs corresponding color and radiance values for each voxel. The color and radiance values of the voxels along the ray are used to calculate a predicted color and radiance of the image pixel. A loss function evaluates the predicted values against the known values for the image pixel and updates parameters of the network accordingly.

Once trained, a NeRF may be integrated into a rendering pipeline to predict the color and radiance values of voxels along a ray projected from a pixel in a novel view into a scene. The predicted color and radiance values are processed to determine the color and radiance values for the pixel. The same steps are performed for all of the pixels in the novel view to produce a synthesized image.

Ideally, a NeRF would be trained on every point in the scene. However, if each possible pixel and each possible voxel for that pixel were sampled, such high-resolution sampling would result in too many ground truth values needed for the training. Some training methods reduce the number of ground truth values used for the training by uniformly sampling pixels and voxels for the sampled pixels. Unfortunately, sparse sampling of the radiance field, while improving the computational efficiency of the training, may degrade the quality of the trained NeRF and thus its ability to accurately represent a 3D scene.

### SUMMARY

Systems, methods, and software are disclosed herein that improve computer vision technology in general, and multiple-view reconstruction and novel view rendering in particular, by improving the training of neural networks. In various embodiments, a neural network (e.g., a NeRF, a neural implicit surface representation, or any combination or variation thereof) is trained using multiple images of a scene captured from different viewing directions. The training is enhanced by varying the loss function for at least some of the pixels in the images.

The loss function may be varied by, for example, adding one or more loss terms to the loss function that are dependent upon a spatial feature or features of the pixel. Example spatial features include—but are not limited to—distances of voxels associated with pixels to a surface of an object in the scene, as well the foreground probabilities of the pixels (that is, whether a given pixel is in the foreground of the scene). Varying the loss terms in this manner encourages the training to focus on certain aspects in the scene. For example, by adding a term to the loss function that is dependent upon the distances of voxels to the surface of an object, the training of the network is encouraged to focus on regions around the surface of the object. Similarly, adding a term that is dependent upon the foreground probabilities of pixels focuses the training on regions associated with the foreground. A combination of dependencies is also possible. For instance, one or more loss terms may be dependent upon distance values, while one or more other loss terms may be dependent upon foreground probability values.

In an embodiment, a method of training the network includes identifying pixels in multiple images of a scene captured from different viewing directions and determining, for each of the pixels, at least a known color value and a known radiance value. The training minimizes a loss function having multiple loss terms, including: a first loss term that is dependent upon at least the known color value and the known radiance value for each of the pixels; and one or more additional loss terms dependent upon at least a spatial value associated with each pixel, such that the loss function varies for at least some of the pixels.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a training environment in an implementation.

FIG. 2A illustrates a training process in an implementation, while FIG. 2B illustrates a corresponding inference process in an implementation.

FIG. 3 illustrates another training environment in an implementation.

FIG. 4A illustrates another training process in an implementation, while FIG. 4B illustrates an associated loss process.

FIG. 5 illustrates an operational scenario in an implementation.

FIG. 6 illustrates a computer vision system in an implementation.

FIGS. 7A-7C illustrate an operational example in an implementation.

FIG. 8 illustrates a training framework in an implementation.

FIG. 9 illustrates a computing system suitable for implementing the various operational environments, architectures, processes, scenarios, and sequences discussed below with respect to the other Figures.

### DETAILED DESCRIPTION

Improved techniques are disclosed herein for training a neural radiance field (NeRF)—and other such artificial neural networks—using multiple images of a scene captured from different viewing directions. The disclosed techniques improve the quality of rendered images produced using a NeRF.

A core idea of NeRF-type neural networks involves training the network to model a scene's radiance field. The network takes 3D coordinates and projection ray direction as input and outputs corresponding color and opacity values. The neural network is trained on a set of images capturing different views of the scene, allowing it to learn the intricate details and lighting conditions. The training process involves optimizing the parameters of the neural network to minimize the difference between the predicted radiance values and the ground truth radiance values determined from the training images. This optimization is typically done using a combination of supervised and unsupervised learning.

The ground truth radiance values derived from the images can be produced by sampling the 3D scenes captured by the 2D images. To achieve such 3D sampling, various NeRF training methods uniformly sample both the image pixels and 3D projection rays extending from the pixels into the scenes. In other words, such 3D sampling samples voxels on rays projecting outward from the sampled pixels towards the scene. However—and as mentioned above—sampling every possible voxel, on every ray associated with every pixel, results in too many ground truth radiance values. Accordingly, some training methods reduce the number of ground truth radiance values used for the training by uniformly sampling pixels and voxels for the sampled pixels.

Some approaches have recognized that, while such sparse sampling can improve the computational efficiency of the training, it may degrade the quality of the trained NeRF and its ability to accurately represent the 3D scene. Guided sampling of voxels along the rays has been employed to reduce the number of ground truth radiance values used for the training in areas of less interest, while mitigating the degradation of the network quality caused by overly sparse training. Such guided sampling has involved uniformly sampling pixels and non-uniformly sampling voxels on the rays projected from the uniformly sampled pixels. Indeed, such guided sampling makes sense intuitively because voxels of the same ray far from the surface do not carry much information with respect to the voxels on or around the surface. Hence, it is possible to sample voxels of the rays only around the surface while maintaining network quality. However, even under this approach, the pixels of the images are still sampled uniformly, although the rate or density of sampling can be increased (or decreased) as desired.

The advantageous techniques disclosed herein are based on a new recognition that—in addition to, or as an alternative to—the non-uniform voxel sampling described above, it is beneficial to vary the loss function based on spatial features or characteristics of pixels. In one approach, losses are introduced for points near the surface of an object, points within an empty ray space, and points belonging to background rays. The added loss encourages the training of a neural network to explore object surfaces and thereby improves the accuracy of the networks.

In various embodiments, the techniques include identifying pixels in multiple images of a scene captured from different viewing directions; determining, for each of the pixels, at least a known color value and a known radiance value; and training the NeRF to minimize a loss function having multiple loss terms. The multiple loss terms may include a first loss term dependent upon at least the known color value and the known radiance value for each of the pixels. In addition, the multiple loss terms may also include one or more additional loss terms dependent upon spatial values determined for voxels associated with each pixel, such that the loss function varies for at least some of the pixels.

The first loss term may be further dependent upon a predicted color value and a predicted radiance value of each of the pixels, which themselves may be determined for each pixel based on predicted color values and predicted radiance values produced by the NeRF for voxels on a ray associated with each of the pixels. Training the NeRF may be accomplished by, for each of the pixels: obtaining, from the NeRF, the predicted color values and predicted radiance values for the voxels on the ray associated with the pixel; and determining the predicted color value and the predicted radiance value for the pixel based on the predicted color values and the predicted radiance values for the voxels on the ray.

Alternatively—or in addition—training the NeRF may also include determining a value of the first loss term based at least on the known color value and the known radiance value the pixel, and the predicted color value and the predicted radiance value of the pixel. The training continues with determining a value of each of the one or more additional loss terms based at least on the spatial value(s) associated with the pixel, followed by computing a result of the loss function based at least on the value of the first loss term and the value of each of the one or more additional loss terms. The parameters of the NeRF may then be updated based on the result of the loss function.

The spatial values may comprise a distance of each of the voxels for a given pixel from the surface of an object in the scene. In such cases, determining the spatial value for each of the voxels is accomplished by determining the distance of the voxel to the surface of the object using a neural implicit representation of a signed distance function (SDF) or a model of an SDF. Determining the distance of the pixel to the surface of the object using the neural implicit representation or model of the SDF may be accomplished by identifying voxels on a ray associated with the pixel, and obtaining, from the SDF, a signed distance of each of the voxels to the object in the scene. Alternatively—or in addition—the spatial value determined for each of the pixels may comprise a probability that the pixel is a foreground pixel.

As mentioned, identifying the pixels in the multiple images of the scene may include selecting, from each of the multiple images, a non-uniform sample of pixels having an overrepresentation of foreground pixels in the non-uniform sample of pixels relative to background pixels in the non-uniform sample of pixels. Optionally, the spatial value in such cases may comprise, for each of the pixels, a distance of the pixel from the surface of an object.

In some embodiments, foreground pixels are determined by performing image segmentation on each of the multiple images to segment each image into the foreground pixels and the background pixels. However, in the same or other embodiments, foreground pixels are determined probabilistically. For example, determining the foreground pixels may be accomplished by, for each pixel in an image, determining a probability that the pixel comprises a foreground pixel, and classifying the pixel as belonging to the foreground pixels or the background pixels based on the determined probability.

In addition, determining the probability that the pixel is a foreground may include supplying image-space coordinates of the pixel as input to an image-space probability density function (PDF) that outputs the probability. In some implementations, a grid-space probability density function (PDF) for the scene is first computed using a neural representation of a signed distance function (SDF) for the scene. The grid-space PDF may then be converted or otherwise transformed into the image-space PDF. Examples of the training methods using SDF as part of their training pipeline include NeuS, VolSDF, and RegSDF methods. Notably, this internal SDF is determined for the foreground object of interest. Hence, it can be advantageous to reuse the SDF determined for training purposes to guide the image segmentation.

Some embodiments are based on recognizing that the image segmentation with internal SDF can be improved by a corresponding transformation of the internal SDF for different viewing directions employed by the training. To that end, some embodiments transform the internal SDF into an extended image space wherein each pixel in the image space is defined by colors and depths. Doing this in such a manner allows to adjust this extended image space to each viewing direction by pruning pixels not visible (not forming an image). Thus, the from a specific viewing direction signed distance of the voxel may be converted into a scene-space probability, which itself may be transformed into an image-space probability. The image-space probability determined for each voxel in the group may then form the basis for determining the probability that the corresponding ray intersects the foreground object.

The trained network, trained at least partially on the filtered set of image pixels and using a loss function that may vary based on spatial features, may then be leveraged by a rendering pipeline configured to generate synthesized images of scenes from novel views. For example, a novel view from an arbitrary viewing direction can be generated by querying the network for predicted color and radiance values at points along rays propagating from the pixels that form the image of the novel view. The predicted color and radiance values are then processed to determine the predicted color and radiance values of the pixels which, aggregated with other pixels determined in the same way, form the image.

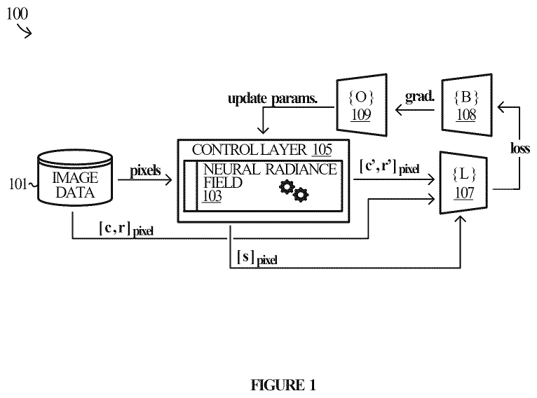

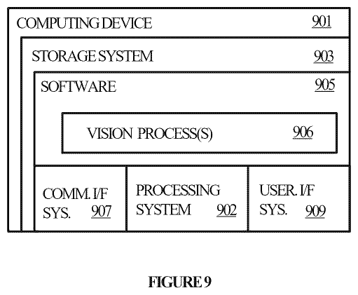

Referring now to the drawings, FIG. 1 illustrates training environment 100 in an implementation. Training environment 100 includes image data 101, Neural Radiance Field (NeRF) 103, control layer 105, loss function 107, backpropagation algorithm 108, and optimizer 109. Training environment 100 may be implemented in computer hardware, software, and/or firmware, an example of which is provided in FIG. 9. It may be appreciated the FIG. 1 illustrates a highly simplified representation of a training environment and that other components in addition to those shown herein may be included.

Image data 101 is representative of images data suitable for training a neural network. Examples include photographs taken by a camera (or cameras) from multiple viewing points with respect to a scene, as well as video captured by a camera (or cameras) from multiple viewing points with respect to a scene. Image data may also represent synthetically generated image data such as that produced by gaming engines, virtual reality applications, or the like.

NeRF 103 is representative of an artificial neural network that may be trained on image data to generate novel views of a scene. NeRF 103 includes various components such as an input layer, hidden layers, parameters such as weights and biases, and an output layer. NeRF 103 takes a voxel coordinate as input, feeds forward the input through the hidden layers to the output layer, and outputs a prediction of the color and radiance of a voxel at a given voxel coordinate provided as input.

Control layer 105 is representative of a software layer, module, or other such component(s) capable of managing or otherwise controlling the training of NeRF 103. Control layer 105 may be implemented as a stand-alone component or its functionality may be integrated into and/or distributed amongst the other components of training environment 100. Control layer 105 serves to manage the process of identifying pixels in training images, identifying voxels on rays associated with the pixels, and inputting corresponding coordinates for the voxels as input to NeRF 103. As NeRF 103 produces voxel predictions as output, control layer 105 may also be tasked with calculating a per-pixel prediction of color and radiance, which may then be fed as input to loss function 107.

Loss function 107 is representative of a function suitable for calculating a value representative of a difference between the color and radiance prediction produced by control layer 105 (based on the voxel predictions produced by NeRF 103), the ground-truth color and radiance values for the pixels, and a spatial feature or characteristic of each pixel. The ground-truth values may be drawn by loss function 107 directly or indirectly from image data 101, or they may be provided directly or indirectly by control layer 105 or any other suitable component of training environment 100. Similarly, the spatial values for the pixels may be included in image data 101 or calculated by control layer 105.

Loss function 107 calculates the loss based on multiple loss terms, including a primary loss term and one or more additional loss terms. The primary loss term is dependent upon the ground truth values provided for the pixels in image data 101, while the one or more loss terms are dependent upon the spatial values. Thus, loss function 107 may be considered a “dynamic” or “variable” loss function since the mechanism by which it calculates loss differs for pixels having different spatial characteristics. For example, the value(s) of the loss term(s) in loss function 107 may differ for pixels of different distances from the surface of an object in a scene. Likewise, the value(s) of the loss term(s) in loss function 107 may differ for foreground pixels relative to background pixels.

Backpropagation algorithm 108 calculates the gradients of the loss with respect to the network's parameters. This involves propagating the error backward through the network to determine how much each parameter contributed to the overall error. The gradients are provided as input to optimizer 109.

Optimizer 109 uses the gradients to update the parameters of NeRF 103 in order to minimize loss function 107. Optimizer adjusts the parameters based on the gradients and a learning rate, which controls the size of the steps taken towards the minimum of the loss function. Different optimizers use different strategies for this adjustment which, generally speaking, ensure that the parameters are updated in a way that reduces the loss.

Adding spatially dependent loss terms to loss function 107 effectively causes optimizer 109 to adjust the parameters in such a manner that encourages the exploration of a scene on a spatial basis and therefore improves the ability of NeRF 103 to render specific regions of a scene. For example, adding loss terms dependent upon distances of pixels to the surface of an object improves the ability of NeRF 103 to render pixels close to the surface. Similarly, adding loss terms dependent upon the foreground probabilities of pixels improves the ability of NeRF 103 to render foreground pixels.

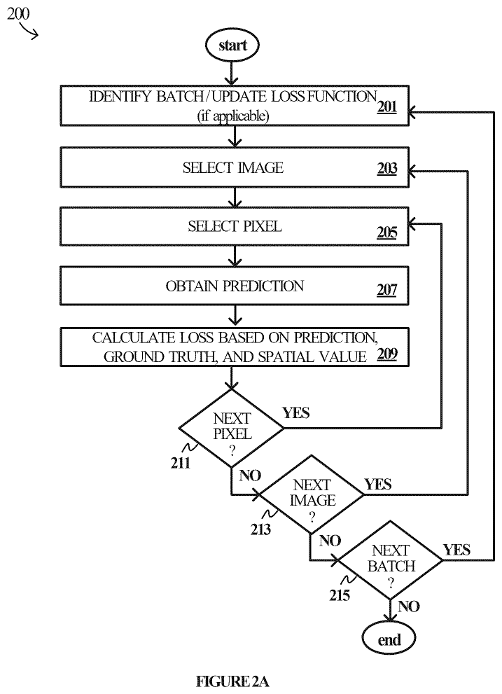

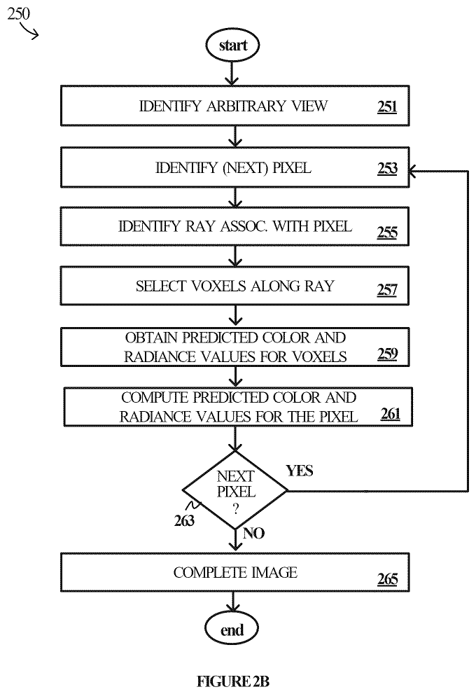

FIG. 2A illustrates a training process 200 employed in the context of training a neural network. Indeed, training process 200 may be implemented in program instructions in the context of the software and/or firmware elements of training environment 100. Training process 200 may be applied once per training epoch, per batch, or at some other cadence or interval when training a neural network. The program instructions, when executed by one or more processing devices of one or more computing systems, direct the one or more computing systems to operate as follows, referring parenthetically to the steps in FIG. 2, and in the singular to a computing device for the sake of clarity.

At a high level, training process 200 processes a set of images of a scene—captured or otherwise produced from multiple viewing perspectives—to train a neural network to render novel views of the scene. Training process 200 does so programmatically by performing various nested loops. The loops include an outer loop that updates the loss function after each batch, an inner loop selects each image in a batch, and another inner loop that processes the pixels in each image. Training process 200 may also include an inner-most loop (not shown) that processes voxels along the rays associated with each of the selected pixels. It may be appreciated that the programmatic technique described by training process 200 is just one high level example of a suitable training algorithm and that other programmatic techniques instead of or in addition to training process 200 are possible and are considered within the scope of the present disclosure.

More specifically, training process 200 begins at the outer loop by identifying a current batch and updating the loss function. Updating the loss function at step 201 includes adding a spatially dependent loss term after each iteration within a batch. For instance, an initial iteration through a batch of images would lack any spatially dependent loss terms in the loss function. A subsequent iteration through the same or a different batch would include one new loss term that is spatially dependent, a next subsequent iteration would include a second new loss term that is spatially dependent, and so on until the iterations are complete. Thus, for the first iteration through training process 200, the loss function may have no spatially dependent loss terms, whereas for the nth iteration, the loss function will include n−1 spatially dependent terms.

Each iteration of training process 200 may consider the same batch of images or a different batch of images. Consider an example where training process 200 iterates over the same batch of images. In such a situation, spatially dependent loss terms would be added iteratively after each batch. For instance, an initial iteration through the same batch of images would lack any spatially dependent loss terms in the loss function. A subsequent iteration would include one new loss term that is spatially dependent, a next subsequent iteration would include a second new loss term that is spatially dependent, and so on until the iterations are complete. In this example, each image will have been processed multiple times using a loss function that varied for each iteration based on the composition of its loss terms.

An alternative example involves iterating over different batches of images, rather than a single batch. In such a scenario, the spatially dependent loss terms are added iteratively after each batch, but because the batches change, the loss function does not vary within a given batch but rather on a per-batch basis. More specifically, an initial iteration through a first batch of images would lack any spatially dependent loss terms in the loss function. A second iteration would include one new loss term that is spatially dependent, but the second iteration would be performed with respect to a second (different) batch of images. A third iteration would include another new loss term—in addition to the first new loss term—that is spatially dependent, but the third iteration would be performed with respect to yet another batch of images that differ from the first and second batches. In this example, the loss function will have varied across batches, but not within a given batch.

Once the loss function has been updated, the computing device selects an image from the set of images in the current batch (step 203). Each image is comprised of multiple pixels. Accordingly, the computing device proceeds to select an initial pixel in the image (step 205). The pixel may be selected from a set of all the pixels in the image or it may be selected from a sampled sub-set of the pixels. For example, the image pixels may be sampled based on foreground probabilities or other criteria to reduce the size of the training set.

Having identified a given pixel, the computing device obtains a prediction of the color and radiance of the pixel (step 207). The prediction is obtained by identifying voxels along a ray associated with the pixel and inputting each voxel's coordinates into the neural network. The neural network outputs color and radiance predictions for each voxel, which may then be processed in the aggregate to arrive at a predicted color value and a predicted radiance value for the current pixel.

At step 209, the computing device calculates a loss value based on the predicted color and radiance values for the pixel, the ground truth color and radiance values for the pixel, and one or more spatial values associated with the pixel (e.g., spatial values for voxels on a ray associated with the pixel). The predicted values and ground truth values may be used by a regular loss term in the loss function that is not dependent upon the spatial value(s), whereas the spatial value(s) may be used in one or more other loss terms that are therefore spatially dependent. The spatial value(s) may be obtained from a signed distance function (SDF), point cloud data, computer aided design (CAD) model data, or the like.

Having calculated the loss for the selected pixel, the computing device determines whether any pixels remain to be processed (step 211). If so, then training process 200 returns to step 205 and the next pixel is selected from the set or subset. If no pixels remain to be processed, then training process 200 proceeds to step 213. At step 213, the computing device determines whether any images remain to be processed. If so, training process 200 returns to step 203 and the selection of the next image. If not, training process 200 proceeds to step 215 where it determines whether any batches remain to be processed. If so, the process returns to step 201. If not, then training process 200 ends.

It may be appreciated that the losses computed by the initial iteration of training process 200 would not be dependent upon any spatial values. However, upon completion of the initial iteration of training process 200, a spatially dependent loss term is be added to the loss function such that the loss computed during a subsequent iteration of training process 200 is dependent upon spatial values. Continuing along these lines, each subsequent iteration of training process 200 introduces an additional loss term that is spatially dependent, such that the portion of the losses computed during each iteration are suitable weighted and effectively added to the existing losses.

A neural network subject to training process 200 is capable of accurately predicting color and radiance values for any voxel location in the 3D scene for which it was trained. Thus, the network may be employed by an image rendering pipeline to reconstruct novel views of the scene. That is, the neural network can be leveraged to produce 2D images that are novel with respect to the training images. FIG. 2B illustrates rendering process 250 in one such example embodiment.

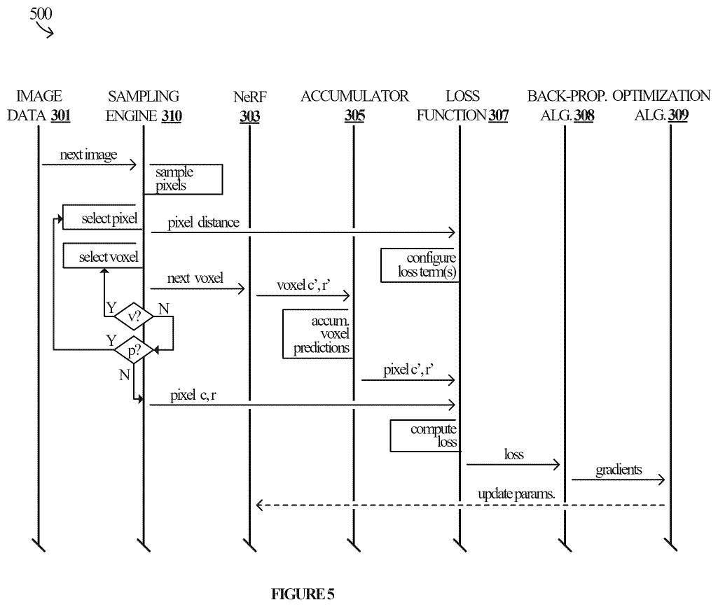

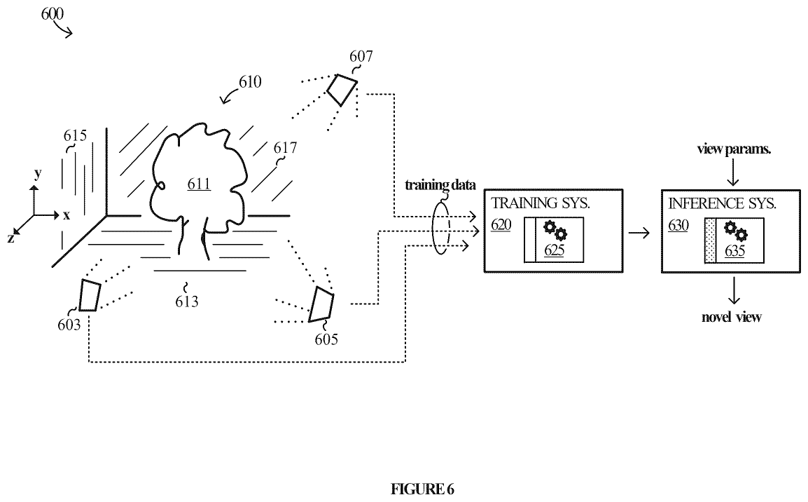

Rendering process 250 may be implemented in program instructions in the context of the software and/or firmware elements of a computer vision application. The program instructions, when executed by one or more processing devices of one or more computing systems, direct the one or more computing systems to operate as follows, referring parenthetically to the steps in FIG. 6, and to a computing device in the singular for the sake of clarity.

In operation, the computing device identifies an arbitrary view of a scene (step 251). The arbitrary view may be indicated by, for example, the direction and angle of a theoretical camera. The computing device then identifies a pixel in a synthesized image to be reconstructed by querying the neural network (e.g., a NeRF) trained in accordance with training process 200 (step 253).

The computing device identifies a ray associated with the current pixel that generally extends in the viewing direction of the synthesized image into the scene (step 255). The computing device then selects voxels along the ray with which to query the network (step 257). The voxels may be selected on a uniform basis, a non-uniform basis, or some combination or variation thereof.

The computing device inputs the location of each voxel one-by-one into the neural network (as well as their orientations), to obtain predicted color and radiance values for each voxel from the network (step 259). The computing device then computes a predicted color and radiance value for the pixel based on the voxels' color and radiance values (step 261).

Steps 251-261 are repeated for each pixel in the synthesized image until, at step 263, a determination is made that no more pixels are to be processed. At that point, the synthesized image is complete, and it may be displayed, saved, shared, or otherwise used (step 265).

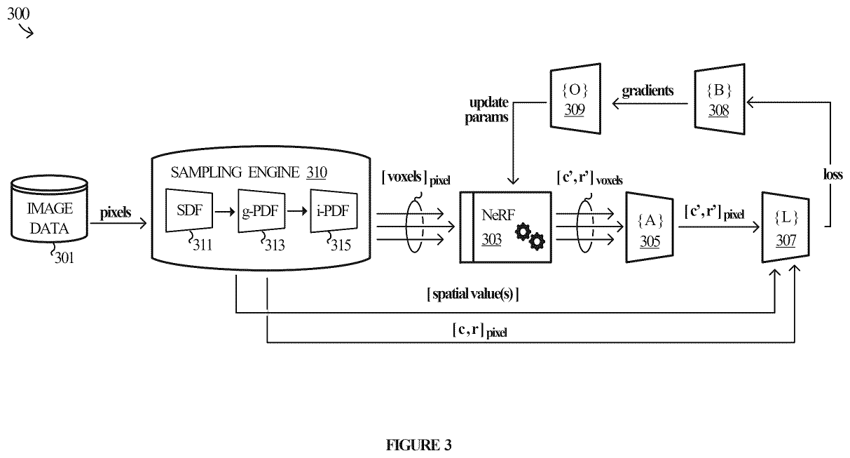

FIG. 3 illustrates another training environment in an implementation. Training environment 300 includes image data 301, NeRF 303, accumulator 305, loss function 307, backpropagation algorithm 308, optimizer 309, and sampling engine 310. Sampling engine 310 includes an implicit representation of a signed distance field, represented by SDF 311, as well as a grid-space probability distance function (g-PDF 313), and an image-space probability distance function (i-PDF 315).

Image data 301 is representative of images data suitable for training a neural network. Examples include photographs taken by a camera (or cameras) from multiple viewing points with respect to a scene, as well as video captured by a camera (or cameras) from multiple viewing points with respect to a scene. Image data may also represent synthetically generated image data such as that produced by gaming engines, virtual reality applications, or the like.

Sampling engine 310 takes image data 301 as input, and outputs training data to be supplied as input to NeRF 303. More specifically, sampling engine 310 takes pixel data as input and outputs feature vectors for voxels along rays associated with the pixels. In addition, sampling engine 310 provides ground-truth color and radiance values for the pixels to loss function 307, as well as spatial values for the pixels (e.g., distance/depth values for voxels on the projection rays corresponding to the pixels and/or foreground probability values for the pixels).

As mentioned, sampling engine 310 includes SDF 311, which is capable of producing a signed distance value for each 3D voxel in a scene. The signed distance value represents the distance of a given voxel from the surface of a foreground object in the scene. A positive value indicates that the voxel is outside the foreground object, while a negative value indicates that the voxel is inside the foreground object. The signed distance value (or a variation thereof) may be provided by sampling engine 310 to loss function 307, although loss function 307 may optionally obtain distance values from other sources such as point cloud data or CAD model data.

Sampling engine 310 uses g-PDF 313 to compute a grid-space probability density value for each voxel based on the signed distance value output by SDF 311. The grid-space probability density value represents the signed distance of each voxel in terms of a value within a range (e.g., between 0 and 1). In other words, the probability density value represents a probability of the signed distance value. Whereas the signed distance represents a distance of the voxel to a surface of the foreground object, the probability density value comprises a real number between 0 and 1 that represents a location of the signed distance of the voxel in a range of signed distance values. In other words, the probability density value represents the chances that a particular voxel is on the surface or not.

Both SDF 311 and g-PDF 313 produce values in terms of the real-world x-y-z coordinates of a scene. Accordingly, sampling engine 310 uses i-PDF 515 to transform the grid-space values produced by g-PDF 313 into image-space values that takes into account the deformation of voxels from the grid space to the image space and/or to account for perspective distortion associated with cameras. Sampling engine 310 uses i-PDF 315 to determine the probability that a given pixel is a foreground pixel, which may be leveraged to sample pixels on a foreground probability basis. Alternatively, or in addition, foreground probabilities may also be used to influence the loss function in addition to or instead of distance values.

NeRF 303 is representative of an artificial neural network that may be trained on image data to generate novel views of a scene. NeRF 303 includes various components such as an input layer, hidden layers, parameters such as weights and biases, and an output layer. NeRF 303 takes a voxel coordinate as input from sampling engine 310, feeds forward the input through the hidden layers to the output layer, and outputs a prediction of the color and radiance of a voxel at a given voxel coordinate that was provided as input to the network.

Accumulator 305 is representative of a software layer, module, or other such component(s) capable of calculating a per-pixel prediction of color and radiance. The per-pixel predictions may then be fed as input to loss function 307. More specifically, accumulator 305 receives the per-voxel predictions output by NeRF 303 and processes them to determine per-pixel predictions, which it then passes as input to loss function 307.

Loss function 307 is representative of a function suitable for calculating a loss value generally representative of and/or related to a difference between the color and radiance prediction produced by accumulator 305 (based on the voxel predictions produced by NeRF 303), the ground-truth color and radiance values for the pixels, and a spatial feature or characteristic of each pixel. The ground-truth values may be drawn by loss function 307 directly or indirectly from sampling engine 310, image data 301, or any other suitable component of training environment 300, while the spatial values are supplied by sampling engine 310 or other sources such as point cloud data or CAD model data.

Loss function 307 calculates the loss based on multiple loss terms, including a primary loss term and one or more additional loss terms. The primary loss term is dependent upon the ground truth values provided for the pixels in image data 301, while the one or more loss terms are dependent upon the spatial values provided by sampling engine 310. Thus, loss function 307 may also be considered a “dynamic” or “variable” loss function.

Backpropagation algorithm 308 calculates the gradients of the loss with respect to the network's parameters. This involves propagating the error backward through the network to determine how much each parameter contributed to the overall error. The gradients are provided as input to optimizer 309.

Optimizer 309 uses the gradients computed by backpropagation algorithm 308 to update the parameters of NeRF 303 in order to minimize loss function 307. Optimizer adjusts the parameters based on the gradients and a learning rate, which controls the size of the steps taken towards the minimum of the loss function.

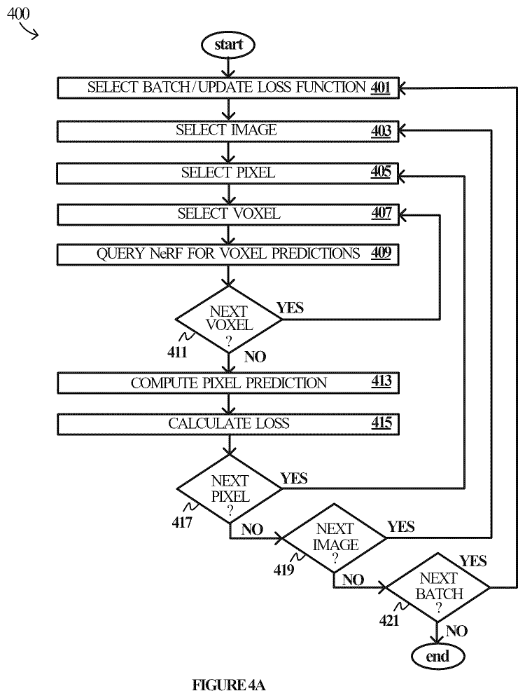

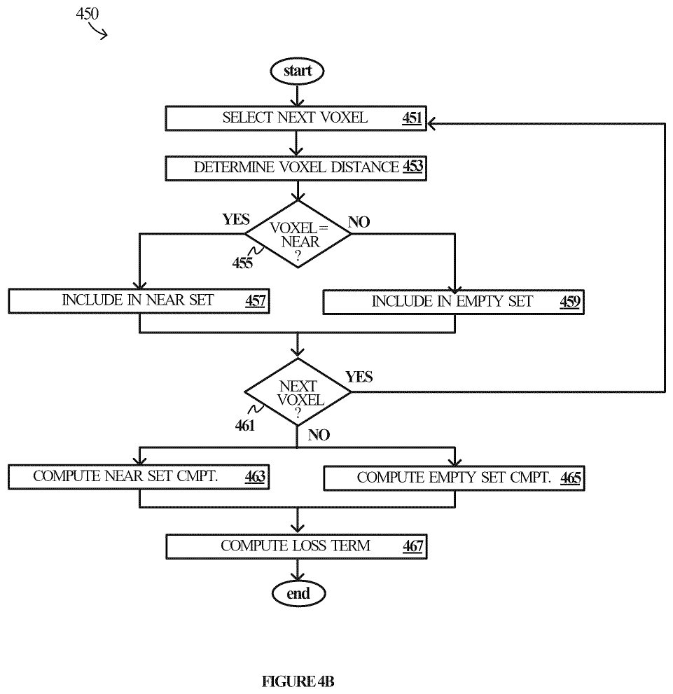

FIG. 4A illustrates a training process 400 employed in the context of training a neural network such as NeRF 303. Training process 400 may be implemented in program instructions in the context of the software and/or firmware elements of training environment 300. Training process 400 may be applied once per batch when training a neural network. The program instructions, when executed by one or more processing devices of one or more computing systems, direct the one or more computing systems to operate as follows, referring parenthetically to the steps in FIG. 4A, and in the singular to a computing device for clarity.

Training process 400 in FIG. 4A processes a set of images of a scene programmatically by performing several nested loops. The loops include an outer loop that updates the loss function after each batch, an inner loop selects each image in a batch, and another inner loop that processes the pixels in each image, and an inner most loop that processes voxels along the rays associated with each of the selected pixels.

More specifically, training process 400 begins at the outer loop by identifying a current batch and updating the loss function. Updating the loss function at step 401 includes adding a spatially dependent loss term after each iteration within a batch. For instance, an initial iteration through a batch of images would lack any spatially dependent loss terms in the loss function. A subsequent iteration through the same or a different batch would include one new loss term that is spatially dependent, a next subsequent iteration would include a second new loss term that is spatially dependent, and so on until the iterations are complete. Thus, for the first iteration through training process 400, the loss function may have no spatially dependent loss terms, whereas for the nth iteration, the loss function will include n−1 spatially dependent terms.

Each iteration of training process 400 may consider the same batch of images or a different batch of images. For instance, training process 400 may iterate over the same batch of images. In such a situation, spatially dependent loss terms would be added iteratively after each batch. In this example, each image will have been processed multiple times using a loss function that varied for each iteration based on the composition of its loss terms.

An alternative example involves iterating over different batches of images, rather than a single batch. In such a scenario, the spatially dependent loss terms are added iteratively after each batch, but because the batches change, the loss function does not vary within a given batch but rather on a per-batch basis. In this example, the loss function will have varied across batches, but not within a given batch.

Once the loss function has been updated, the computing device selects an image from the set of images in the current batch (step 403). Each image is comprised of multiple pixels. Accordingly, the computing device proceeds to select an initial pixel in the image (step 405). The pixel selection step may occur after pixels have been sampled from the image by sampling engine 310. Optionally, the pixel selection step may include the sampling step(s) carried out by sampling engine 310. Thus, the pixel may be selected or sampled from a set of all the pixels in the image or it may be selected from an already-sampled subset of the pixels.

Having identified a given pixel, the computing device identifies a set of voxels along a ray associated with the pixel and iterates through the voxels. At step 407, the computing device selects one of the voxels and, at step 409, queries the neural network (e.g., NeRF 303) for a prediction of the selected voxel's color and radiance.

At step 411, the computing device determines whether any voxels remain. If so, training process 400 returns to step 407. If not, the computing device proceeds to compute a prediction of the selected pixel's color and radiance values based on the color and radiance values predicted for the voxels along the pixel's ray (step 413). The computing device then proceeds to calculate the loss based on the predicted pixel values, the ground truth pixel values, and a distance value or values determined for the pixel's voxel(s) (step 415).

Calculating the loss involves executing a loss function that takes the predicted values and ground truth values as inputs, as well as the distance value. The predicted values and ground truth values are used by a first loss term in the loss function that is not dependent upon the distance value, whereas the distance value is used in the one or more other loss terms added iteratively after each batch. The additional loss terms are spatially dependent by virtue of their dependence upon the distance value(s) of a given pixel. (Term computation process 450 discussed below represents one specific technique for computing spatially dependent loss terms.)

Having calculated the loss for the selected pixel, the computing device determines whether any pixels remain to be processed (step 417). If so, then training process 400 returns to step 405 and the next pixel is selected from the set or subset. If no pixels remain to be processed, then training process 400 proceeds to step 419. At step 417, the computing device determines whether any images remain to be processed. If so, training process 400 returns to step 403 and the selection of the next image. If not, training process 400 determines whether any batches remain to be processed (step 421). If so, training process 400 returns to step 401. If no batches remain, the training process ends.

It may be appreciated that the losses computed by the initial iteration of training process 400 would not be dependent upon any spatial values, as no spatially dependent loss terms are included in the loss function at this point. However, upon completion of the initial iteration of training process 400, a spatially dependent loss term is be added to the loss function such that the loss computed during a subsequent iteration of training process 400 is dependent upon spatial values. Continuing along these lines, each subsequent iteration of training process 400 introduces an additional loss term that is spatially dependent, such that the portion of the losses computed during each iteration are effectively added to the existing losses.

FIG. 4B illustrates a term computation process 450 for computing the spatially dependent loss terms for a given pixel. Term computation process 450 may be implemented in program instructions in the context of the software and/or firmware elements of training environment 300. The program instructions, when executed by one or more processing devices of one or more computing systems, direct the one or more computing systems to operate as follows, referring parenthetically to the steps in FIG. 4B, and in the singular to a computing device for the sake of clarity.

Term computation process 450 begins with the computing device selecting a voxel from a set of voxels on a projection ray associated with a given pixel (step 451). The voxels may be the same voxels utilized in training process 400. Next, the computing device determines the distance of the voxel to the surface of an object in a scene (step 453). The distance (or depth) may be obtained by, for example, querying an SDF, point cloud data, or computer aided design (CAD) model data.

The computing device then determines whether the voxel is sufficiently close to the surface of an object to be included in a near set of voxels (step 455). If the voxel satisfies a distance threshold, it is included in a near set of voxels (step 457). If the voxel does not satisfy the distance threshold, it is included in an empty set of voxels (step 459).

The computing device continues to iterate through the remaining voxels in this manner until determining at step 461 that there are no more voxels in the sampled set. From there, the computing device computes a near-term component of the spatially dependent loss term using radiance values of the voxels in the near set (step 463). The computing device also computes an empty-term component of the spatially dependent loss term using radiance values of the voxels in the empty set (step 465). The functions used to compute the near-term component and empty-term component both include a variable associated with the voxels distances, but otherwise vary relative to each other (see below with respect to the detailed framework discussion). The computing device then computes the spatially dependent loss term based on the near-term component and the empty-term component (step 467).

A neural network subject to training process 400 and term computation process 450 is capable of accurately predicting color and radiance values for any voxel location in the 3D scene for which it was trained. Thus, the network may be employed by an image rendering pipeline to reconstruct novel views of the scene. That is, the neural network can be leveraged to produce 2D images that are novel with respect to the training images. (FIG. 2B above illustrates a suitable rendering process 250 in one such example embodiment.)

FIG. 5 illustrates an operational sequence 500 in an implementation that is representative of an application of training process 400 to training environment 300. Operational sequence 500 occurs in the context of an iteration of training process 400 that is subsequent to the initial iteration of training process 400. That is, operational sequence 500 assumes that assumes that one or more spatially dependent loss terms have already been added to loss function 307 by virtue of multiple preceding iterations of training process 400.

Operational sequence 500 begins with sampling engine 310 processing an image from the batch to select a subset of samples. Sampling engine 310 may sample the pixels based on their foreground probabilities. For instance, sampling engine 310 iterates through the image pixels to compute the foreground probability of each pixel. This is accomplished by querying the i-PDF 315 with the x-y coordinates of the pixel in the image space. I-PDF 315 returns a value used to classify the pixel as a foreground pixel or a background pixel. Foreground pixels are included in the sampled set of pixels to a non-uniform degree such that the sample of pixels produced by sampling engine 310 has an overrepresentation of foreground pixels in the sample of pixels relative to background pixels in the sample. The resulting sample is therefore a “non-uniform” sample of pixels with respect to their foreground characteristics.

It may be appreciated that not all foreground pixels need be included in the training set, nor are all background pixels excluded from the training set. Rather, whether the selected pixel is ultimately included in the training set may also depend upon the relevant sampling profile at the moment. For example, the sampling profile may call for the inclusion of at least some background pixels in the training set, meaning that even if a pixel is classified as a background pixel, it may still be included in the set. It may further be appreciated that the pixel sampling step described above could be omitted. That is, in some embodiments, all of the pixels in an image or a set of images in a batch could be used for training purposes. In other cases, the pixels of some of the images in a batch may be sampled on a foreground probability basis, while such sampling may be omitted with respect to the pixels in others of the images in the batch.

Sampling engine 310 ultimately produces a set of voxels for each pixel in the sampled set of pixels. Sampling engine 310 does so by iterating through each pixel in the sampled set and selecting voxels along a ray associated with each pixel. The voxels may also be sampled on a uniform or non-uniform basis. That is, just as the sampling of pixels may be guided based on foreground probabilities, the sampling of voxels along rays may be guided based on uniform or non-uniform sampling strategies. In one example, voxels may also be sampled based on their respective distances to the surface of an object in a scene.

Focusing on a single pixel for the sake of clarity, sampling engine 310 provides the distances of the pixel's voxels to the surface of an object in the scene to loss function 307, which loss function 307 uses to derive one or more additional loss terms. Sampling engine 310 may obtain the distance values from SDF 311 using the coordinates of the pixel. (Sampling engine 310 also, either concurrently or separately with respect to providing the distance value, provides ground truth color and radiance values for the pixel to loss function 307.

Having identified the sample set of voxels, sampling engine 310 proceeds to query NeRF 303 on an iterative basis with the 3D coordinates in the scene of each sampled voxel. Sampling engine 310 may do so on an individual basis, for instance by supplying a vector representation of the coordinates of a single voxel to NeRF 303. NeRF 303 receives the coordinates as input, feeds-forward their values through the network, and outputs a prediction of the color and radiance values of the voxel. Sampling engine 310 proceeds to do the same for all of the voxels in the sampled set, the results of which are used by accumulator 305 to compute a prediction of the color and radiance values of the pixels corresponding to the voxels.

Accumulator 305 provides the pixel-level prediction to loss function 307. Loss function 307 computes a result of a non-spatially dependent loss term based on the predicted color and radiance values for the pixel and the ground truth color and radiance values. Loss function 307 also computes the result of one or more spatially dependent loss terms based on the distance value(s) provided by sampling engine 310. Loss function 307 computes a final result based on the results of both the non-spatially dependent loss term and the one or more spatially dependent loss terms.

The result produced by loss function 307 are provided backpropagation algorithm 308. Back propagation algorithm 308 calculates gradients of the loss with respect to the network's parameters and supplies the gradients to optimizer 309. Optimizer 309 uses the gradients to update the network's parameters.

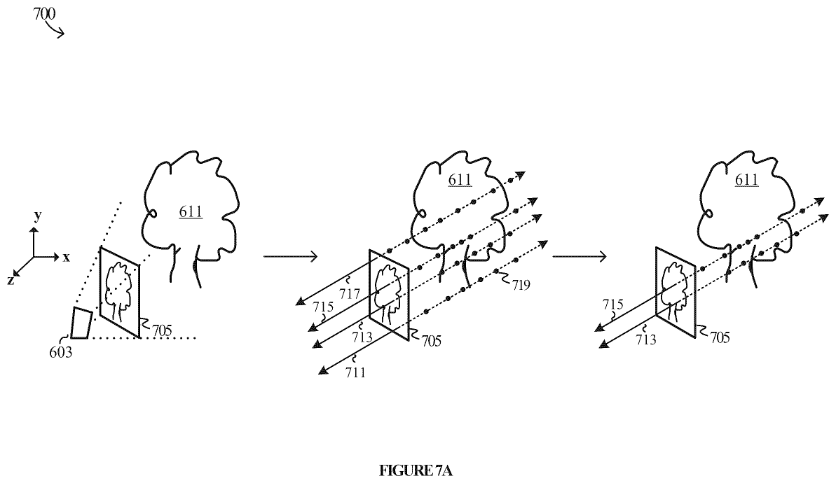

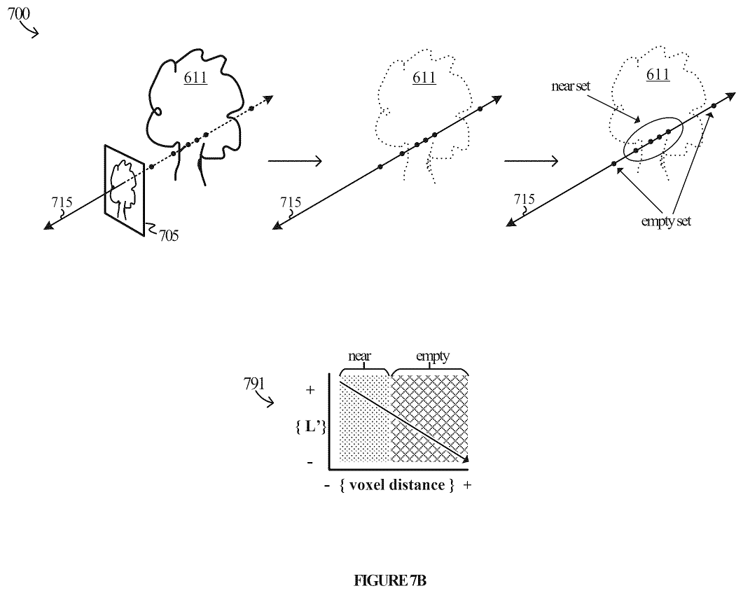

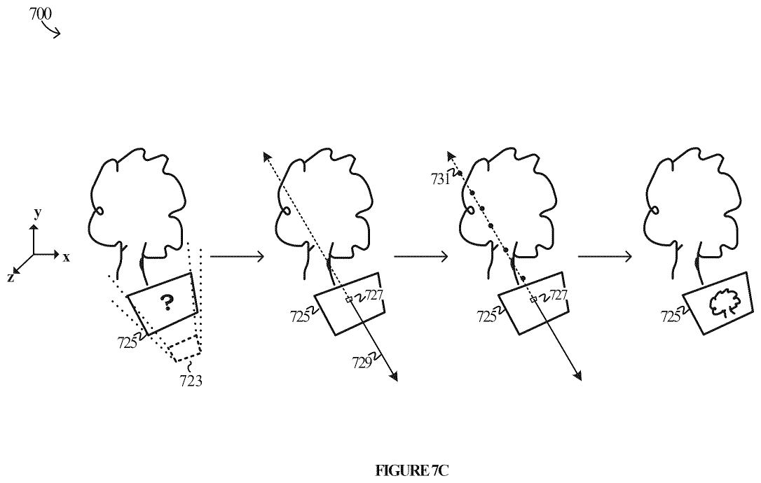

FIG. 6 illustrates a computer vision environment 600 in which the concepts disclosed above may be applied, while FIGS. 7A-7C disclose an operational scenario with respect to computer vision environment 600 that is representative of both the training phase and inference phase of a NeRF.

Computer vision environment 600 includes scene 610, training system 620, and inference system 630. Scene 610 provides the source of imagery on which to train a NeRF 625. NeRF 635 represents a trained instance of NeRF 625. NeRF 635 may be deployed by inference system 630 to produce novel views of scene 610.

Computer vision environment 600 further includes image capture devices represented by cameras 603, 605, and 607. Cameras 603-607 each capture 2D images of scene 610, which provide some or all of the training data processed by training system 620. Scene 610 is a 3D scene that includes an object 611 (representing a tree in this example) surrounded on three sides by wall 615, wall 617, and ground 613. While shown here as multiple individual cameras, it may be appreciated that a single camera could be used to capture all of the images from all of the viewing directions. In addition, while only three different viewing directions are shown, it may be appreciated that many more viewing directions are possible (e.g., 20-30, or more). In addition, the images could be captured in video rather than individual still images. Finally, while scene 610 is primarily envisioned as a real scene captured real image capture devices, the concepts disclosed herein for training and executing a model apply as well to images captured of or otherwise produced with respect to a synthetic scene such as those rendered by gaming engines, virtual reality engines, or the like.

In FIGS. 7A-7C, operational scenario 700 illustrates an application of training process 200 and 400 to scene 610, as well as term computation process 450 and rendering process 250.

In operation, camera 603 captures an image 705 of the scene, including object 611 (a tree). The other cameras do as well, although they are not shown for purposes of clarity. Thus, image 705 forms part of a training set, along with the other images captured by the other cameras at different locations (or by the same camera at the different locations).

Next, a sampling process is applied to the images in the training data. Here, the sampling process is illustrated as applied to just image 705, although it would be applied as well to the other images in the training set.

The sampling process leverages a neural representation of an SDF to generate a grid-space PDF. Using rays 711-717 projected through the pixels of image 705 into the scene to illustrate the point, the SDF represents a signed distance of each voxel along the ray to a foreground object. Rays 711-717 represent only a limited number of the total number of rays for the sake of clarity, and only a small number of voxels are shown for the sake of clarity. The SDF may be queried using the x-y-z location of each voxel in grid-space to obtain its signed distance value.

Next, the sampling process transforms the grid-space PDF to an image-space PDF. The image-space PDF may be queried using the x-y coordinates of a pixel in image-space to obtain a probability that the pixel corresponds to a foreground object in the scene. In simpler terms, the sampling process determines the likelihood that a ray extending outward from a given pixel intersects a foreground object in the scene. If so, then the pixel can be classified as a foreground pixel. If not, then the pixel can be classified as a background pixel.

In FIG. 7A, it is shown and assumed for exemplary purposes that ray 717 and ray 711 do not intersect object 611. Accordingly, the pixels corresponding to ray 717 and ray 711 may be excluded from the training dataset, at least for one training epoch (if not more). Accordingly, only rays 713 and 715 are used to train the model.

FIG. 7B illustrates an application of term computation process 450 with respect to ray 715. In particular, FIG. 7B represents how a loss function may be varied based on the distances of the voxels on ray 715 from the surface of object 611.

Six (6) voxels are shown for illustrative purposes along ray 715. Moving right to left, or from image 705 into the scene, the first voxel and the last voxel are sufficiently distant from object 611 to be classified as part of an empty set. In contrast, the middle four (4) voxels are near enough to object 611 to be classified as part of a near set. The voxels in the empty set are used to compute the empty set component of a spatially dependent loss term of the loss function. The voxels in the near set are used to compute the near set component of the spatially dependent loss term of the loss function.

Graph 791 depicts the relative effect of voxels in the near set on the variance of a loss function relative to voxels in the empty set. Generally speaking, voxels nearer to the surface of an object have a greater impact on the variance (increase) of the loss function relative to the impact caused by objects more distant from the object. It may be appreciated that the slope of the line in graph 791 is merely intended to demonstrate this basic relationship, as opposed to a more specific relationship that would depend upon the specific functions employed to calculate additional loss terms, examples of which are provided below with respect to the discussion of the software framework.

In FIG. 7C, it is assumed for exemplary purposes that a neural network has been trained based on a sampled data set produced in accordance with the illustration in FIGS. 7A and 7B. That is, the neural network may be trained on a sampled training set that is disproportionately focused on foreground pixels over background pixels. In addition, the loss function is varied on a per-pixel basis to encourage exploration on a spatial basis.

Per the training processes disclosed herein, the neural network is trained to output color and radiance values for voxels along rays projected outward from novel views into a scene. The voxel values are then used to compute color and radiance values for a corresponding pixel which, in the aggregate, form an image of the novel view.

Here, a novel view 725 is projected from a hypothetical camera 723. The position and orientation of the hypothetical camera 723 determines the position and orientation of the novel view 725 and its image pixels. For each pixel 727 in the novel view 725, the rendering process projects a ray 729 through the view into the scene. The rendering process samples voxels along ray 729 (e.g., voxel 731) and inputs their x-y-z coordinates into the neural network. The neural network outputs a predicted color and radiance value for each pixel. The rendering process accumulates the values and processes them to determine a predicted color and radiance value for each pixel (e.g., pixel 727). The pixel values in the aggregate form the synthesized image of the novel view 725.

### Framework Discussion

The following sections describe in more detail a framework for implementing the concepts discussed above. The framework may be implemented in program instructions in the context of software and/or firmware elements. The program instructions, when executed by one or more processing devices of one or more computing systems, direct the one or more computing systems to operate as described below with respect to the framework.

### Framework Summary

The disclosed framework leverages the implicit surface representation of the foreground scene and model a probability density function in a 3D image projection space to achieve a more targeted sampling of the rays toward regions of interest, resulting in improved rendering. Additionally, a new surface reconstruction loss is proposed for improved performance. This new loss fully explores the proposed 3D image projection space model and incorporates near-to-surface and empty space components. By integrating a novel sampling strategy and novel loss into any current state-of-the-art neural implicit surface renderer, the framework achieves more accurate and detailed 3D reconstructions and improved image rendering, especially for the regions of interest in any given scene. The proposed framework employs a novel, probability-guided sampling strategy, that results in improved scene rendering, seamlessly merging with other neural surface rendering pipelines.

### Notations

Let a 3D point in world coordinates be given by x=[x, y, z]∈ [symbol] ⊂ [symbol] ³. For a set of cameras C={1, . . . , C}, the same point in the cth camera, is denoted by \hat{x}_{c}=[\hat{x}_{c}, ŷ_{c}, \hat{z}_{c}]∈ [symbol] _{c}. h_{c}(⋅) transforms the point from the world to the camera c (see [?]). For c, a three-dimensional image space is defined such that:

$${u}_{c} ∈ {𝒰}_{c} = g ( {\hat{x}}_{c} ) = [ {\hat{x}}_{c} / {\hat{z}}_{c} , {\hat{y}}_{c} / {\hat{z}}_{c} , {\hat{z}}_{c} ] = [ {u}_{c} , {v}_{c} , {λ}_{c} ] , \qquad ( 1 )$$

where u_{c}, v_{c}, and [symbol] _{c} (respectively) are bounded to image size and intrinsic parameters of each camera, and depth λ_{c}>0, which is bijective to the camera reference frame. Using the transformation from the world to the camera coordinate system h_{c}(⋅) and image projection g(⋅) (for more detail see [?]), the composition f_{c}(⋅) is defined such that

$${u}_{c} = {f}_{c} ( x ) = g ( {h}_{c} ( x ) ) . \qquad ( 2 )$$

To simplify the notations, subscripts may be omitted: the subscript c, for example, u=u_{c}, and \hat{x}=\hat{x}_{c}. Finally, |⋅| denotes the determinant of a matrix.

### Neural Implicit Surface Rendering

Consider a set of images of a specific 3D scene, captured from calibrated cameras with known poses. A NeRF creates an implicit 3D representation of the scene from known camera positions to the images. This implicit representation allows for a dense reconstruction of the scene, by simultaneously estimating the volume density and color for every 3D point. A more evolved approach is to estimate the densities from an SDF representation by approximating it using a logistic function:

$${ϕ}_{s} ( o ) = ( s {e}^{- s o} ) / ( 1 + {e}^{- s o} ) , \qquad ( 3 )$$

where s is the logistic scale and o the SDF output. This conversion enables the application of camera-free volume rendering techniques for scene reconstruction. Using the SDF, the scene's outer surface [symbol] is represented as the zero-level set, defined as [symbol] ={x∈ [symbol] ³: S(x)=0}, where S(⋅) is the output of the SDF network. The rendering is then computed using the SDF at a particular 3D point. The volume density at each point along the ray is:

$${α}_{i} = max ( \frac{{Φ}_{s} ( S ( {x}_{i} ) ) - {Φ}_{s} ( S ( {x}_{i + 1} ) )}{{Φ}_{s} ( S ( {x}_{i} ) )} , 0 ) , \qquad ( 4 )$$

where Φₛ(⋅) is the sigmoid function. The accumulated volume density is:

$${W}_{i} = {α}_{i} {T}_{i} = {α}_{i} {\prod }_{j = 0}^{i} ( 1 - {α}_{j} ) , \qquad ( 5 )$$

where Tᵢ is the transmittance at the point i along the ray. See [?] for details.

### Method Overview

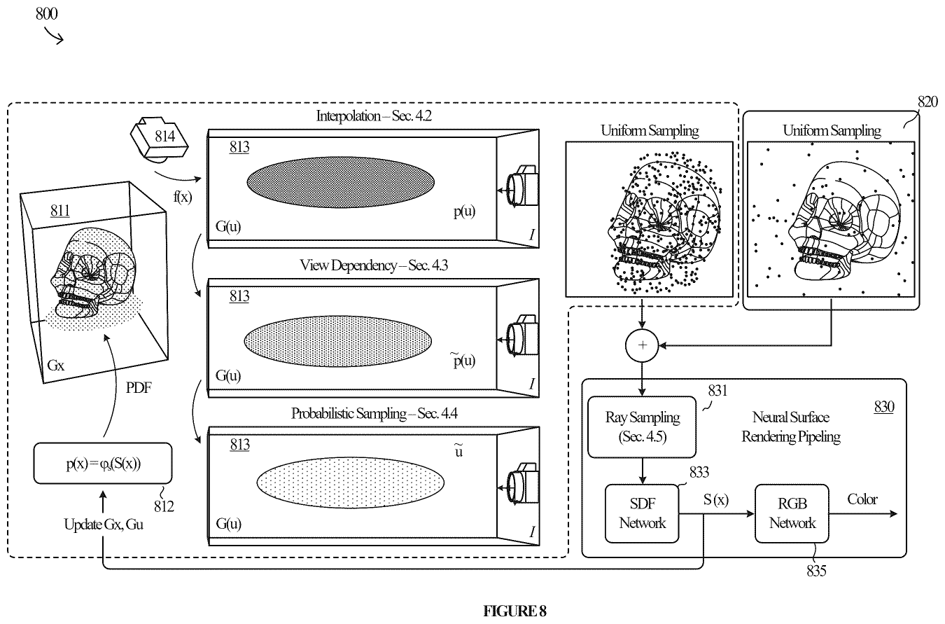

Consider a typical neural surface rendering pipeline, such as the one proposed by NeuS. An intermediate step of such methods consists of obtaining an SDF that models the 3D structure of the foreground of a scene. The disclosed framework utilizes the SDF for more effective sampling while training the neural volume field. In particular, the framework focuses on the important regions of the scene, i.e., foreground, when training. Additionally, the framework leverages the output information from its sampling module to aid the sampling process along the rays and the training with additional surface reconstruction losses. The method does not require any additional information (e.g., SfM points) or models. The proposed training pipeline is depicted in FIG. 8 and is discussed in more detail below.

The framework starts by leveraging the SDF representation in Eq. 3 to define a Probability Density Function (PDF) over the points in the 3D scene to capture the likelihood of it being sampled during training, denoted as p(x):

$$p ( x ) = {ϕ}_{s} ( S ( x ) ) . \qquad ( 6 )$$

Then, the framework explores a suitable 3D image space from p(x) for effective sampling in the camera's viewpoint. To compute the probability in a 3D image space, the transformation has to be bijective and consequently invertible to account for the change of variables. From a geometric point of view, the proposed space U is obtained from X by transforming the projection rays, which, by definition, are parallel to each other and perpendicular to the image space (i.e. orthographic projection space). The new PDF is p(u).

Next, the framework deals with the concerns arising from view dependency, such as occlusions. Rather than sampling directly in the image from the scene's projection and probabilities, where awareness of the viewpoint is limited, the framework weighs the camera's PDF p(u) using a volume rendering strategy. This allows for seamless integration of view dependency constraints and provides the foundation for the sampling process. This PDF is defined as is p(u).

The final step of the formulation consists of sampling 3D points on U using p(u). The proposed method follows a conditional sampling strategy detailed below, which describes how the sampled u is used in the neural surface pipeline and details the proposed surface regularization losses designed to guide the training process by considering the sampled depth.

### Interpolation

The framework aims to transform the density estimate p(x)), for a point x∈X to the 3-dimensional image space, defined in Eq. 1, which is denoted by p(v), where v∈U. This transform is given by:

$$p ( x ) = p ( {f}^{- 1} ( v ) ) \vert \frac{\partial {f}^{- 1} ( v )}{\partial } \vert p ( {f}^{- 1} ( v ) ) = {η}^{- 2} p ( x ) , \qquad ( 7 )$$

where v=f(x) and η the depth value of v.

To simplify and have a more compact representation, the framework discretizes the 3D scene space x, such that x∈GX⊂X, and the 3D image space of u such that u∈GU⊂U, with G_{X} and G_{U} denoting a discretized grid on X and U. Note that v is not represented in the grid of the 3-dimensional image space G_{U}. Instead, v is discretized according to the scene grid G_{X} after applying the camera transformation f(⋅) in Eq. 2, which is defined as Gf(X). However, the probability estimates p(u) in G_{U} cannot be easily interpolated from Eq. 7 due to the respective space deformation resulting from the discretization and transformation. Therefore, the framework approximates p(u) as the Riemann integral of all transformed cells of G_{X} in u. The framework starts by making sure G_{X} is discretized finely. For each u∈G_{U}, the probability estimate is the sum of the probability densities of all points Gf(X) that lie inside the cell, as defined in Eq. 7.

### View Dependency

Since p(u) does not account for occlusions created by the camera's perspective projection, therefore, sampling a projection ray based on the object's geometry alone can result in too many occluded samples and, consequently, loss of training efficiency (since the network would focus on learning the occlusions). To address this issue, the framework assumes that the volume density σ per cell is p(u) as a naive solution. The transmittance T can then be easily evaluated in the three-dimensional image space by accumulating the radiance weighted by the volume densities for cells along the ray, corresponding to the image coordinates [u, v]. Considering the grid G_{U}, the transmittance Tᵢ at the depth λᵢ corresponding to the i-th cell along [u, v] can be defined as

$${T}_{i} = {e}^{- {\sum }_{k = 1}^{i} p ( {[ u , v , {λ}_{k} ]}^{T} )} ,$$

where the k^{th}-cell is sorted by depth. Then, the view-dependent probability \tilde{p}(uᵢ) for uᵢ=[u, v, λᵢ]^{T} is defined as the transmittance weighted by the volume density accumulated along a ray, such that

$$\tilde{p} ( {u}_{i} ) = {σ}_{i} {T}_{i} = p ( {u}_{i} ) {e}^{- {\sum }_{k = 0}^{i} p ( {[ u , v , {λ}_{k} ]}^{T} )} . \qquad ( 8 )$$

### Probability-Guided Sampling

While in the previous neural rendering pipelines, the pixels are sampled in the image uniformly, this framework combines the two sampling strategies, viz.: both (i) the sampling using the view-dependent space PDF \tilde{p}(u), and (ii) sampling uniformly on the image since the former is better suited for the foreground while the latter for the background, allowing the framework to regulate the proportion of samples from the two regions of the scene.

Starting with the view-dependent space sampling, the framework uses conditional probabilities, which extend the ray importance sampling over previous solutions to the 3-dimensional space U. The first marginal density function is then defined as:

$$\tilde{p} ( u ) = \frac{1}{{R}_{v} {R}_{λ}} {\sum }_{( v , λ )} \tilde{p} ( {[ u , v , λ ]}^{T} ) \qquad ( 9 )$$

for all (v, λ) cells of u, where Rᵥ and R_{λ} are resolutions of the grid along the axes of v and λ. Then, the first conditional distribution is then computed as:

$$\tilde{p} ( v , λ \vert u ) = \frac{\tilde{p} ( u )}{\tilde{p} ( u )} . \qquad ( 10 )$$

The second marginal applied to v can then be expressed as:

$$\tilde{p} ( v \vert u ) = \frac{1}{{R}_{λ}} {\sum }_{λ} \tilde{p} ( v , λ \vert u ) , \qquad ( 11 )$$

for all λ cells.

Finally, the second conditional distribution is then defined as:

$$\tilde{p} ( λ \vert u , v ) = \frac{\tilde{p} ( v , λ \vert u )}{\tilde{p} ( v \vert u )} . \qquad ( 12 )$$

With the marginals and conditionals defined, the framework guides the sampling of points ũ=[ũ, \tilde{v}, \tilde{λ}]∈U in the three-dimensional image space, to obtain the 3D projection ray and image pixels, respectively. The framework starts by sampling ũ from the first marginal using inverse transform sampling. Then, the framework approximates the second marginal p(v|ũ) from the samples ũ using bilinear interpolation. Following the same inverse sampling strategy, \tilde{v} is sampled according to p(v|ũ). Finally, using trilinear interpolation, the framework approximates the second conditional p(λ|ũ, ũ), with ũ and \tilde{v}, and sample \tilde{λ}. When sampling uniformly along the rays across the image during training and evaluation, the framework interpolates the second conditional with given values for ũ and \tilde{v}, and sample \tilde{λ} directly.

### Surface Reconstruction Losses

The input to the rendering network (irrespective of what backbone used) are the 3D points sampled along the rays projected into the 3D scene from the sampled pixels as described above. In addition to the 3D points obtained by following the sampling strategy of the backbone network, the framework provides additional 3D points along the ray near the estimated surface for improved rendering of such regions. This is accomplished by drawing samples from a Gaussian distribution

$$∼ 𝒩 ( \tilde{λ} , \frac{{π}^{2}}{3 {s}^{2}} ) ,$$

where the variance is determined by the normal approximation of the logistic distribution, with the mean being the sampled \tilde{λ}.

In addition to losses considered on the backbone, the framework introduces additional losses for points near the surface, considered to be a zero-level set, points within the empty ray space, and points belonging to background rays, during training.

Consider M projection rays and N_{fg} foreground points sampled along those rays. The proposed near-surface loss accounts for sampled points within 99.7% of the possible near-surface samples during ray sampling, i.e., points for the m-th ray, where m∈{1, . . . , M}, satisfying

$${𝒩}_{Near} = \{ f ( x ) ∈ U : f ( x ) ∈ [ ( u , v , \tilde{λ} - 3 \frac{π}{\sqrt{3} s} ) , ( u , v , \tilde{λ} + 3 \frac{π}{\sqrt{3} s} ) ] \} ,$$

and is given by:

$${L}_{m}^{Near} = {\sum }_{i ∈ {𝒩}_{Near}} \vert S ( {}_{i} ) \vert {w}_{i} , \qquad ( 13 )$$

where S(⋅) is the SDF value, and wᵢ represents the volume density accumulated along a ray of the point i, given by Eq. 5.

For points in the empty ray space, i.e., the complement set of [symbol] _{Near} in the ray, denoted as [symbol] _{Empty}, the framework introduces a loss to encourage small SDF values and promotes exploration:

$${L}_{m}^{Empty} = {{\sum }_{j ∈ {𝒩}_{Empty}} [ ( S ( {}_{j} ) - ϵ ) {w}_{j} ]}^{2} , \qquad ( 14 )$$

where ϵ is a small value. The framework considers view dependency in both losses by incorporating the accumulated volume densities, wₐ, where a∈{i, j}.

Finally, for rays that do not intersect foreground surfaces, i.e., if the sampled depth \tilde{λ} is outside of the scene's boundary, the following background loss ensures that the importance of accurately estimating the scene geometry decreases as one moves farther from the surface:

$${L}_{m}^{B g} = {\sum }_{k = 1}^{{N}_{fg}} {e}^{- β \vert S ( {}_{i} ) \vert} {w}_{k} . \qquad ( 15 )$$

All losses are averaged by over M rays. The total surface loss is computed as L^{Surf}=λ₁L^{Near}+λ₂(L^{Empty}+L^{Bg}). This surface loss is appropriately weighted and added to the existing losses for each backbone.

### Example Discussion

FIG. 8 illustrates an application of the framework discussed above. FIG. 8 considers a neural surface rendering pipeline (pipeline 830). Framework 800 extends the sampling of rays to consider a scene's geometry by using a surface model estimate. The scene 811 is represented as a 3D grid Gₓ, and characterized by a PDF 812 [p(x)] computed from an SDF network 833 in pipeline 830 and modeled by a logistic distribution 812 of the SDF values ϕₛ(S(x)). Usually, rays are sampled uniformly in the image space. However, with knowledge of the scene, framework 800 uses a 3D image space (that includes depth), represented as Gᵤ, where one can define p(u)—based on p(x). This PDF is interpolated by transforming the points from Gₓ according to f(x) to the current camera space and finely discretizing to interpolate the new PDF 813 in Gᵤ. The framework considers the camera viewpoint 814 of the scene, by weighting p(u). In the 3D image space, a line perpendicular to the image plane is the ray by definition. Thus, by considering p(u) as the volume density, the framework weighs the new PDF 815 [\tilde{p}(u)]. In the shown grids, color hue maps to the probability value, normalized for each grid. A higher hue is more probable. Points with very low probabilities are filtered. At every training step, and considering the 3D dimensions, a number of points are sampled from \tilde{p}(u) to create ray samples 816 [ũ]. Note that this ray will contain depth information for the importance sampling in the ray tracing.

Additionally, the framework samples rays uniformly (uniform sampling 820) to avoid overfitting the network to the more intricated scene parts, since the proposed solution focuses solely on surface areas. The sampled rays (guided and uniform) are trained as the usual neural surface rendering pipeline 830, which includes ray sampling 831, an SDF network 833, and an RGB network 835. The proposed framework need not change the backbone models and can be inserted in similar pipelines. However, the loss functions in the networks may be modified dynamically based on spatial features to further guide their training.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes and implements vision process 906, which is representative of training process 200, rendering process 250, training process 400, and term computation process 450. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, digital signal processors, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (vision process 906) may be implemented in program instructions and among other functions may, when executed by processing system 902, direct processing system 902 to operate as described with respect to the various operational scenarios, sequences, frameworks, and processes illustrated and/or discussed herein. For example, software 905 may include program instructions for implementing the sampling, training, and/or rendering processes described herein, as well as the probabilistic guided sampling and dynamic loss computations discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to perform computer vision processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method for training a neural radiance field (NeRF) comprising:
identifying pixels in multiple images of a scene captured from different viewing directions;
determining, for each of the pixels, at least a known color value and a known radiance value; and
training the NeRF to minimize a loss function having multiple loss terms;
wherein the multiple loss terms include a first loss term dependent upon at least the known color value and the known radiance value for each of the pixels; and
wherein the multiple loss terms further comprise, for each of the pixels, one or more additional loss terms dependent upon at least a spatial value associated with each pixel.

2. The method of claim 1 wherein the spatial value is not an input to the NeRF, and wherein the first loss term is further dependent upon a predicted color value and a predicted radiance value of each of the pixels determined for each pixel based on predicted color values and predicted radiance values produced by the NeRF for voxels on a ray associated with each of the pixels.

3. The method of claim 2 wherein training the NeRF comprises, for each of the pixels:
obtaining, from the NeRF, the predicted color values and predicted radiance values for the voxels on the ray associated with the pixel; and
determining the predicted color value and the predicted radiance value for the pixel based on the predicted color values and the predicted radiance values for the voxels on the ray.

4. The method of claim 3 further comprising:
determining a value of the first loss term based at least on the known color value and the known radiance value the pixel, and the predicted color value and the predicted radiance value of the pixel; and
determining a value of each of the one or more additional loss terms based at least on the spatial value associated with the pixel.

5. The method of claim 4 further comprising:
computing a result of the loss function based at least on the value of the first loss term and the value of each of the one or more additional loss terms; and
updating parameters of the NeRF based on the result of the loss function.

6. The method of claim 1 wherein the spatial value associated with each of the pixels comprises a distance, of a voxel on a ray associated with the pixel, from a surface of an object in the scene, and wherein the method further comprises determining the spatial value using a neural implicit representation of a signed distance function (SDF).

7. The method of claim 6 wherein determining the distance comprises:
selecting the voxel from a set of voxels on the ray associated with the pixel; and
obtaining, from the neural implicit representation of the SDF, a signed distance of the voxel to the object in the scene.

8. The method of claim 1 wherein the spatial value comprises a probability that the pixel is a foreground pixel.

9. The method of claim 1 wherein identifying the pixels in the multiple images of the scene comprises selecting, from each of the multiple images, a non-uniform sample of pixels having an overrepresentation of foreground pixels in the non-uniform sample of pixels relative to background pixels in the non-uniform sample of pixels.

10. The method of claim 9 wherein the spatial value comprises, for each of the pixels, a distance of each voxel, of a set of voxel on a ray associated with the pixel, from a surface of an object in the scene.

11. A computing apparatus comprising:
one or more computer readable storage media; and
program instructions, stored on the one or more computer readable storage media, for training a neural radiance field (NeRF) using multiple images of a scene captured from different viewing directions;
wherein the program instructions, when executed by one or more processors, direct the computing apparatus to at least:
identify pixels in multiple images of a scene captured from different viewing directions;
determine, for each of the pixels, at least a known color value and a known radiance value; and
train the NeRF to minimize a loss function having multiple loss terms;
wherein the multiple loss terms include a first loss term dependent upon at least the known color value and the known radiance value for each of the pixels; and
wherein the multiple loss terms further comprise one or more additional loss terms dependent upon at least a spatial value associated with each pixel.

12. The computing apparatus of claim 11 wherein the spatial value is not an input to the NeRF, and wherein the first loss term is further dependent upon a predicted color value and a predicted radiance value of each of the pixels determined for each pixel based on predicted color values and predicted radiance values produced by the NeRF for voxels on a ray associated with each of the pixels.

13. The computing apparatus of claim 12 wherein, to train the NeRF, the program instructions further direct the computing apparatus to, for each of the pixels:
obtain, from the NeRF, the predicted color values and predicted radiance values for the voxels on the ray associated with the pixel; and
determine the predicted color value and the predicted radiance value for the pixel based on the predicted color values and the predicted radiance values for the voxels on the ray.

14. The computing apparatus of claim 13 wherein the program instructions further direct the computing apparatus to:
determine a value of the first loss term based at least on the known color value and the known radiance value the pixel, and the predicted color value and the predicted radiance value of the pixel;
determine a value of each of the one or more additional loss terms based at least on the spatial value associated with the pixel;
compute a result of the loss function based at least on the value of the first loss term and the value of each of the one or more additional loss terms; and
update parameters of the NeRF based on the result of the loss function.

15. The computing apparatus of claim 11 wherein the spatial value associated with each pixel comprises a distance of a voxel, on a ray associated with the pixel, from a surface of an object in the scene determined using a neural implicit representation of a signed distance function (SDF) or a model of an SDF.

16. The computing apparatus of claim 11 wherein the spatial value associated with each pixel comprises a probability that the pixel is a foreground pixel.

17. The computing apparatus of claim 11 wherein, to identify the pixels in the multiple images of the scene, the program instructions direct the computing apparatus to select, from each of the multiple images, a non-uniform sample of pixels having an overrepresentation of foreground pixels in the non-uniform sample of pixels relative to background pixels in the non-uniform sample of pixels.

18. The computing apparatus of claim 11 wherein the spatial value comprises, for each pixel, a distance of a voxel, on a ray associated with the pixel, from a surface of an object in the scene.

19. A memory having program instructions stored thereon for training a neural network using multiple images of a scene captured from different viewing directions;
wherein the program instructions, when executed by one or more processors of a computing device, direct the computing device to at least:
identify pixels in multiple images of a scene captured from different viewing directions;
determine, for each of the pixels, at least a known color value and a known radiance value; and
train the neural network to minimize a loss function having multiple loss terms;
wherein the multiple loss terms include a first loss term dependent upon at least the known color value and the known radiance value for each of the pixels; and
wherein the multiple loss terms further comprise one or more additional loss terms dependent upon at least a spatial value associated with each pixel.
